(19) United States
(12) Patent Application Publication
(10) Pub. No.: US 2015/0081703 A1
(43) Pub. Date: Mar. 19, 2015

(54) PROVIDING LABELS FOR PHOTOS

(71) Applicant: Google Inc., Mountain View, CA (US)

(72) Inventors: Erik Murphy-Chutorian, Palo Alto, CA (US); Stanislav Moreinis, Mountain View, CA (US)

(73) Assignee: Google Inc., Mountain View, CA (US)

(21) Appl. No.: 14/487,874

(22) Filed: Sep. 16, 2014

Related U.S. Application Data
(60) Provisional application No. 61/878,392, filed on Sep. 16, 2013.

(51) Int. Cl. G06F 17/30

(52) U.S. Cl. CPC G06F 17/30554; G06F 17/30268
USPC 707/736

(57) ABSTRACT

Systems, methods and computer readable media for providing labels for photos are described herein. In some implementations, a method can include receiving a plurality of photos. The method can also include associating one or more labels with the plurality of photos based on one or more predetermined criteria. The method can also include determining one or more suggested labels from the one or more labels to be used as search terms, and providing for the suggested labels for display in a user interface.

### RELATED APPLICATIONS

This application claims the benefit of U.S. Provisional Patent Application No. 61/878,392, entitled “Providing Labels for Photos” and filed on Sep. 16, 2013, which is incorporated herein by reference in its entirety.

### BACKGROUND

Sharing photos has become an increasingly popular activity. For example, people attending the same event often share photos taken at the event with each other. People can share photos by using an online service (e.g., a social network), passing around memory cards, or via messaging (e.g., email, text message or the like). Social network systems often enable users to upload photos and to create photo albums containing the uploaded photos. Some social network systems may enable a user to apply tags such as captions or labels to photos.

### SUMMARY

Implementations generally relate to providing labels for photos. Some implementations can include a method. The method can include receiving a plurality of photos, and associating one or more labels with the plurality of photos based on one or more predetermined criteria. The method can also include determining one or more suggested labels from the one or more labels to be used as search terms. The method can further include providing the suggested labels for display in a user interface.

The method can also include searching the plurality of photos in response to a selection of one or more of the suggested labels received via the user interface. The predetermined criteria can include a criterion based on a source of the photos. The predetermined criteria can include a criterion based on visibility of the plurality of photos. The predetermined criteria can include a criterion based on ownership of the plurality of photos.

The predetermined criteria can include a criterion based on a target user being tagged in one or more of the plurality of photos. The predetermined criteria can include a criterion based on a type of device used to capture the photos. The predetermined criteria can include a criterion based on a brand of device used to capture the photos.

The method can further include presenting the predetermined criteria as corresponding hash tags associated with the plurality of photos. The search terms can be hash tags associated with the plurality of photos. The suggested labels can be based on one or more predefined suggestion criteria.

The method can also include receiving an indication of a user action related to one or more of the suggested labels. The method can further include updating a label association technique based on the received user action.

Some implementations can include a system comprising one or more processors configured to perform operations. The operations can include receiving a plurality of photos. The operations can also include associating one or more labels with the plurality of photos based on one or more predetermined criteria. The operations can further include determining one or more suggested labels from the one or more labels to be used as search terms. The operations can also include providing the suggested labels for display in a user interface.

The operations can further include searching the plurality of photos in response to a selection of one or more of the suggested labels received via the user interface. The predetermined criteria can include a criterion based on one or more of a source of the photos, visibility of the plurality of photos, ownership of the plurality of photos, a target user being tagged in one or more of the plurality of photos, a type of device used to capture the photos, a brand of device used to capture the photos.

The operations can also include receiving an indication of a user action related to one or more of the suggested labels. The operations can further include updating a label association technique based on the received indication.

Some implementations can include a nontransitory computer readable medium having stored thereon software instructions that, when executed by a processor, cause the processor to perform operations. The operations can include receiving a plurality of photos. The operations can also include associating one or more labels with the plurality of photos based on one or more predetermined criteria. The operations can further include determining one or more suggested labels from the one or more labels to be used as search terms. The operations can also include providing the suggested labels for display in a user interface.

The operations can further include searching the plurality of photos in response to a selection of one or more of the suggested labels received via the user interface. The predetermined criteria can include a criterion based on one or more of a source of the photos, visibility of the plurality of photos, ownership of the plurality of photos, a target user being tagged in one or more of the plurality of photos, a type of device used to capture the photos, a brand of device used to capture the photos.

The operations can also include receiving an indication of a user action related to one or more of the suggested labels. The operations can further include updating a label association technique based on the received indication.

In some implementations, a method can include receiving a plurality of photos. The method can also include associating one or more labels with the plurality of photos based on one or more predetermined criteria. The method can also include suggesting labels from the one or more labels to be used as search terms, and presenting the labels in a user interface.

With further regard to the method, in one embodiment, the method can also include searching the plurality of photos. In some implementations, the predetermined criteria can be based on the source of the photos. In some implementations, the predetermined criteria can be based on the visibility of the photos. In some implementations, the predetermined criteria can be based on the ownership of the photos.

In some implementations, the predetermined criteria can be based on a target user being tagged in one or more of the plurality of photos. In some implementations, the predetermined criteria can be based on a type of device used to capture the photos. In some implementations, the predetermined criteria can be based on a brand of device used to capture the photos.

With further regard to the method, in some implementations, the method can also include presenting the predetermined criteria as #tags (or hash tags) associated with the plurality of photos. In some implementations, the search terms are #tags associated with the plurality of photos. In some implementations, the suggested labels are based on one or more predefined suggestion criteria.

### BRIEF DESCRIPTION OF THE DRAWINGS

FIG. 1 illustrates a block diagram of an example network environment, which may be used to implement the implementations described herein.

FIG. 2 illustrates an example simplified flow diagram for providing labels, according to some implementations.

FIG. 3 illustrates a block diagram of an example computing device, which may be used to implement the implementations described herein.

FIG. 4 is a flowchart of an example machine learning process for providing labels in accordance with some implementations.

FIG. 5 is a diagram of an example user interface for providing labels for photos in accordance with some implementations.

### DETAILED DESCRIPTION

Implementations described herein relate to providing labels for photos. As described in more detail below, in some implementations, a system receives photos from users (e.g., users of a social network system). The system then associates one or more labels with the photos based on one or more predetermined criteria. For example, in some implementations, the predetermined criteria may include a determination that photos have been automatically backed up to a photo library. The system may then associate a label (e.g., “#AutoBackup”) with the photos. Other example implementations of predetermined criteria are described in more detail below.

In some implementations, the system suggests labels from the one or more labels to be used as search terms. The system may then present the suggested search terms in a user interface. The system may associate a “#” or hashtag character with the label. The “#” can be used with any label, and assist in making the label searchable by providing a common identifier so that labels can be searched in groups. For example, a user may search for photos based on one or more labels, and the system may suggest “#PhotosofMe” as a search term. In an example implementation, when the user selects “#PhotosofMe” the system performs a search of the photos and returns given photos associated with the label “#PhotosofMe.”

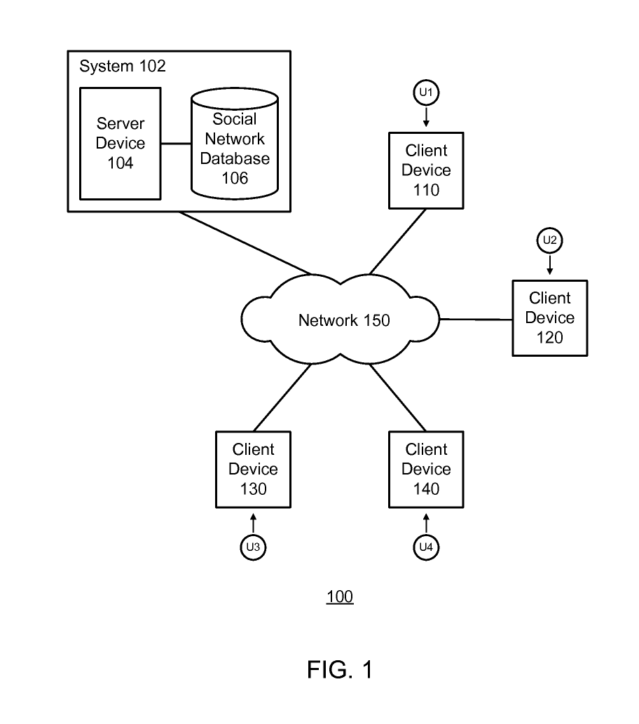

FIG. 1 illustrates a block diagram of an example network environment 100, which may be used to implement the implementations described herein. In some implementations, network environment 100 includes a system 102, which includes a computing device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, computing device 104, and social network database 106, and shows four blocks for client devices 110, 120, 130, and 140. Blocks 102, 104, and 106 may represent multiple systems, computing (e.g., server or user/client devices), and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may interact with each other, where respective client devices 110, 120, 130, and 140 transmit various media content (e.g., photos, photo albums, messages, posts, etc.) to each other directly or via a service (e.g., social network).

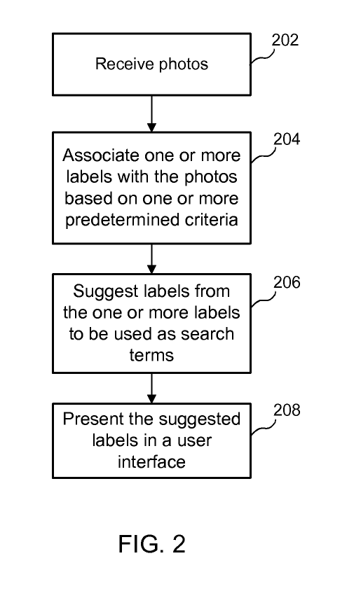

FIG. 2 illustrates an example simplified flow diagram for providing labels for photos, according to some implementations. Referring to both FIGS. 1 and 2, a method is initiated in block 202, where system 102 receives photos. System 102 may receive the photos from one or more users (e.g., users of a social network system). In various implementations, the photos may be received when a given user uploads photos to system 102 or after the user adds the photos to photo albums and/or photo libraries. In some implementations, system 102 may enable a camera device (e.g., a camera-equipped smart phone) of the user to automatically upload photos to system 102 as the camera device captures photos.

In block 204, system 102 associates labels sometimes referred to as tags, and/or hash tags (“#’) with the photos. In various implementations, system 102 automatically associates labels with photos based on one or more predetermined criteria. For example, one or more predetermined criteria may be based on the source of given photos. For example, in various implementations the source of given photos may be an automatic backup from a device. System 102 may then associate the label “#AutoBackup” with the photos.

In some implementations, the source of given photos may be a shared drive on a server. System 102 may then associate the label “#Drive” with the photos. In some implementations, the source of given photos may be that the photos were received via email from another user. System 102 may then associate the label “#Email” with the photos.

In some implementations, one or more predetermined criteria may include a determination that one or more photos are attached to a post, and that a user is associated with the post. In some implementations, the user may be associated with the post by being a recipient of the post and/or being mentioned in the post. In some implementations, the user may be associated with the post by being in one or more photos attached to the post. In some implementations, system 102 may utilize a recognition algorithm to determine if the user is in one or more of the photos. System 102 may then associate the label “#FromPosts” with the photos.

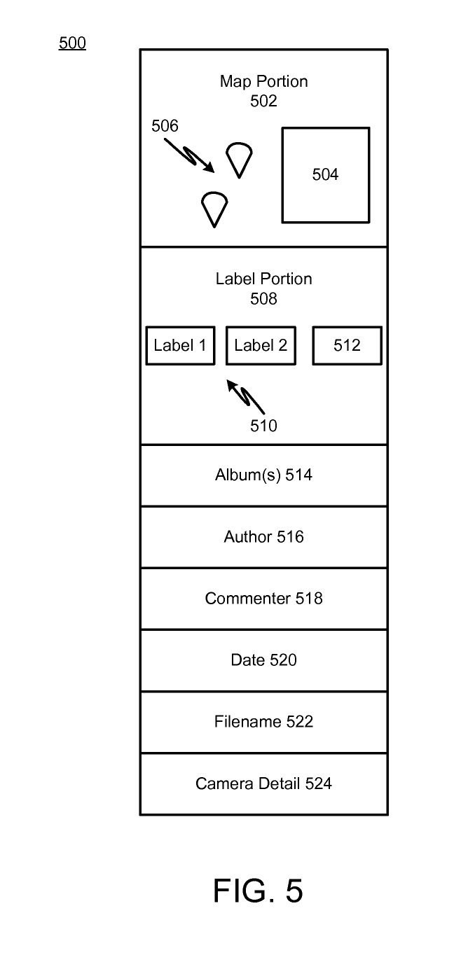

In some implementations the source of given photos may be a particular device. System 102 may then associate the label of the type and/or brand of the device with the photos (e.g. “#FromMobile,” “#FromWearable,” “#FromBrandCamera,” or the like). System 102 may also associate a label representing one or more camera details (e.g., make, model, lens type or the like) with a photo. A user could then search photos by clicking (or tapping) on the name of a camera (or camera detail) in a photo details user interface (e.g., FIG. 5).

In some implementations, one or more predetermined criteria may be based on the visibility of given photos. For example, in various implementations, one or more predetermined criteria may include a determination that one or more photos are directly shared with the user, and wherein the one or more photos are shared by one or more other users who have a social affinity that meet a predetermined social affinity threshold. System 102 may then associate the label “#Shared” with the photos.

In some implementations, one or more predetermined criteria may include a determination that one or more photos are not shared with other users. System 102 may then associate the label “#Unshared” with the photos.

In some implementations, one or more predetermined criteria may include a determination that a user has manually associated a label with one or more photos. For example, system 102 may provide for display (e.g., on a user device) a user interface that allows the user to enter text for label and then system 102 associates the label with the given photos. System 102 may then associate the label “#UserLabel” with the photos, in addition to the existing label that the user created. This enables a user to search all photos that are labeled by the user.

In some implementations, one or more predetermined criteria may include a determination that one or more photos are attached to a post and the user is tagged in one or more of the attached photos. System 102 may then associate the label “#Tagged” with the photos.

In some implementations, one or more predetermined criteria may be based on the ownership of given photos. For example, in various implementations the user and other users may upload photos to a shared album. In some implementations, one or more predetermined criteria may include a determination that the user uploaded the photos, and system 102 may then associate the label “#MyPhotos” with the photos. In some implementations, one or more predetermined criteria may include a determination that other users uploaded the photos to the shared album, and system 102 may then associate the label “#FromContacts” with the photos. In some implementations, the other users are part of a social network group and system 102 may then also associate the label “#FromGroups” with the photos.

In some implementations, one or more predetermined criteria may be based on the editing and/or image processing of given photos. For example, in various implementations the user (or an image processing system) may edit, enhance, crop or change photos. In various implementations system 102 may then associate corresponding labels with photos (e.g., “#Edited,” “#Enhanced,” “#Cropped,” or the like).

In some implementations, one or more predetermined criteria may include a determination that the photos were captured during an event, and that the user attended the event. In various implementations, an event may be any meeting or gathering of people in a geographic location, or at or around a given date and time. Such events may include conventions, parties, meetings, online video conferences or the like.

In some implementations, one or more predetermined criteria may include a determination that the photos do not include any user applied labels or automatically associated labels. System 102 may then associate the label “#Unlabeled” with the photos. In some implementations, one or more predetermined criteria may include a determination that one or more photos include an associated label, and system 102 may then associate the label “#Labeled” with the photos. The automatically associated labels may be taken from a “whitelist” of preapproved labels.

In some implementations, one or more predetermined criteria may include a determination to apply a general label to all the photos (e.g., “#All”).

In various example implementations, one or more predetermined criteria may include a determination that the photos show images of the user. In some implementations, system 102 may utilize a recognition algorithm to determine if the user is in a given photo. In an implementation, system 102 may then associate the label “#PhotosOfMe” with photos that show an image of the user.

In some implementations, one or more predetermined criteria may include a determination that the photos show particular features, objects, colors, and/or landmarks based on a recognition algorithm. In an implementation, system 102 may then associate labels corresponding to recognized features (e.g., “#Tree,” “#Car,” “#EmpireStateBuilding”).

In some implementations, one or more predetermined criteria may include location information about where the photos were captured. In some implementations, location information may be obtained from a device (e.g., based on global positioning system (GPS) or other location determining capabilities of a device) that automatically updates system 102 with device location. In one implementation, system 102 may determine device location based on a user's social check-in data. In some implementations, system 102 may detect location information based on geotagging, landmark recognition, or any other suitable means.

In some implementations, one or more predetermined criteria may include temporal information about the time where the photos were captured. In some implementations time may be obtained from a device, from system 102, based on GPS capabilities of a device, social check-in data, or any other suitable means.

In some implementations, one or more predetermined criteria may include calendar data about the particular day the photos were captured. In some implementations the photos may have been captured on a holiday. In some implementations, system 102 may automatically associate tags related to the holiday (e.g., “#Halloween,” “#Christmas,” “#Thanksgiving,” or the like).

In some implementations, one or more predetermined criteria may include whether a photo is a featured content photo, a social engagement measure (e.g., a high popularity score, received a lot of attention on a social network, has been re-shared or re-posted a given amount or the like). In some implementations, one or more predetermined criteria may include one or more image quality characteristics, one or more visual quality scores or the like.

In some implementations, a user may wish to search a photo album or photo library for particular photos. For example the user may search for particular photos using a search query. In other implementations, user may search for particular photos by clicking on or selecting a label associated with given photos.

In block 206, system 102 may suggest a group of one or more labels (“suggested labels”) from the one or more labels to use as search terms in a search query. In some implementations, system 102 suggests labels based on one or more predefined suggestion criteria. In various implementations described herein, system 102 implements the one or more predefined suggestion criteria to suggest labels that would most likely be interesting and/or useful to the user.

In various implementations, system 102 uses the predefined suggestion criteria to suggest labels, where the labels may have varying degrees of relevancy to the user. In various implementations, system 102 may determine a relevancy score for each label based on various relevancy factors (e.g., the frequency with which the label is associated with given photos, how recently the label was associated with given photos, etc.). Example implementations directed to relevancy factors and other factors are described in more detail below.

For example, in some implementations predefined suggestion criteria may include frequency criteria. In various implementations, system 102 may determine a label frequency count for one or more labels based on the number of times one or more labels is automatically associated with the photos. In other implementations, the system 102 may determine a label frequency count for one or more labels based on the number of times the label is manually associated by users with the photos. For example, system 102 may determine “#Shared” is a frequently used label based on frequency criteria, and accordingly suggest “#Shared” as a search term for a search query.

In some implementations, predefined suggestion criteria may include temporal criteria. In various implementations, system 102 may determine how recently one or more labels were associated with the photos. For example, the user may have just recently applied the given label “#Dog” to particular photos. System 102 may then determine the suggested label “#Dog” as the search term for a search query to search the photos.

In some implementations, predefined selection criteria may include interest criteria. In various implementations, system 102 may determine an interest level of one or more labels associated with the photos. For example, system 102 may assign a higher relevancy score to one or more labels corresponding to famous landmarks. For example, system 102 may determine the suggested label “#EmpireStateBuilding” based on a high relevancy score assigned to this famous landmark.

In some implementations, predefined suggestion criteria may include user added criteria. For example, system 102 may assign a higher relevancy score to one or more labels manually added by the user versus one or more labels automatically added by system 102.

In various implementations, the predefined suggestion criteria may include social affinity criteria. For example, the social affinity criteria may include whether the name of a friend or family member or the name of a social network group of the user is used as a given label (e.g., “#Joe,” “#Family,” etc.). System 102 may determine whether names used in one or more labels are friends or family members of the user based on a social graph of the user.

System 102 may rank suggested labels based on the one or more predefined suggestion criteria. For example, system 102 may rank the suggested labels based on scores associated with relevance (e.g., frequency, temporal, interest, social affinity, or the like).

Referring again to FIG. 2, system 102 in block 206 may provide for presentation the suggested labels, based on predefined suggestion criteria to the user in a user interface. In some implementations, the user interface is a search interface provided for searching photos (e.g., in a photo album, photo library, social network system, or the like). User search queries may be processed using search techniques to generate search results of given photos.

In some implementations, system 102 may present suggested labels that may be used as search terms, before the user even begins to initiate a search query in the user interface. For example, system 102 may present interesting suggested labels or suggested labels with a high rank in the user interface. For example, the user interface may include a text box, and the user may enter a search query into a text box. In some implementations, the user may select (e.g., click or tap) on the suggested labels presented in the user interface and system 102 then adds the selected labels as search terms in a text box. In some implementations, the user may then add additional terms manually to the text box prior to initiating a search.

In some implementations, the user may simply select (e.g., click or tap) on the suggested labels presented in the user interface and system 102 immediately initiates a search based on the selected suggested labels and returns given photos in the search results. In some implementations, system 102 may suggest search terms for a search query based on initial characters, words, and/or phrases entered by the user into text box. For example, in some implementations, the user may enter “E” and system 102 may then suggest the “#EmpireStateBuilding” label as the search term.

In some implementations system 102 may suggest search terms using an autocomplete technique. For example, the user may enter “Emp” into the text box and system 102 may cause to display “ire State Building,” immediately adjacent to “Emp,” which if accepted by the user will cause system 102 to populate the text box with the suggested label “#Empire State Building.”

In some implementations, suggested labels are provided for display in the user interface, by system 102 in an arrangement or manner that is based on a ranking of suggested labels according to one or more suggested criteria. For example, if label “#AutoBackUp” is associated more frequently with given photos than the label “#Email,” system 102 may cause “#AutoBackUp” to display in a higher position in a list of suggested labels in a user interface. In some implementations, system 102 may indicate a higher rank for a given suggested label by changing the manner of presentation of the given suggested label (e.g., highlight, underline, change color, or the like).

In some implementations, the user may manually enter a search term into a user interface, and system 102 determines that the manually entered search term corresponds to an automatically associated label. Accordingly, system 102 may then suggest the automatically associated label to the user as a search term. For example, the user may be searching for images stored in a cloud drive or shared drive that the user manually previously tagged with the word “drive.” Accordingly, the user types the word “drive.” System may then suggest the suggested label “#Drive,” which was previously automatically associated by system 102 with all photos uploaded to the cloud drive or shared drive. If the user includes the suggested label “#Drive” as a search term, system 102 will return all photos associated with the label “#Drive.”

In various implementations, relevancy scores and corresponding ranks of suggested labels may be partially based on the use and selection of suggested labels in the user search interface. For example, system 102 may increase the rank of suggested labels or modify the rank based on selection and use of particular suggested labels in the user search interface. For example, system 102 may increase the rank of suggested labels that the user enters or clicks on more frequently in the user search interface.

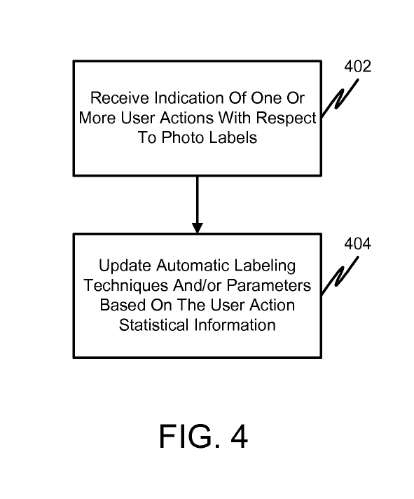

In some implementations, suggested labels could be provided for display in any suitable type of user interface that displays the photos. For example, the user may be viewing the photos in a photo library or photo album. System 102 may cause suggested labels to be displayed on or near the photos. See, e.g., FIG. 4 and corresponding description below.

In some implementations, actions that a user takes with respect to one or more labels while viewing photos may be used to modify the rank of suggested labels. For example, if a user selects a given suggested label to be associated with the photos, system 102 may increase the rank of that selected suggested label. In some implementations, if the user deletes or removes a label from given photos, system 102 may decrease the rank of the corresponding suggested label.

In various implementations, when the user performs or executes a search using suggested labels, system will return corresponding search results of photos associated with the labels.

Implementations described herein provide various benefits. For example, implementations may facilitate the labeling or tagging of photos. Implementations may enable users to expedite searches for photos with minimal effort by users Implementations may enable users to more efficiently organize photos. Implementations may enable users to obtain relevant search results when searching photo libraries and albums. Implementations described herein may also increase overall engagement among users in a social networking environment. Implementations described herein may increase the ease of tagging photos on mobile devices or wearable computers.

Although implementations generally describe labels aiding users in searching photos, other uses for labeling are possible, such as systems automatically grouping and/or displaying like-labeled photos together. While image files are described in these implementations, other types of files are also possible (e.g., video files). Although the steps, operations, or computations in the method implementations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

In various implementations, system 102 may utilize a variety of image recognition algorithms to recognize faces, landmarks, objects, etc. in photos. Such recognition algorithms may be integral to system 102. System 102 may also access recognition algorithms provided by software that is external to system 102 and that system 102 accesses.

In various implementations, system 102 may be configured to enable users of the social network system to specify and/or consent to the use of personal information, which may include the system 102 using their faces in photos or using their identity information in recognizing people identified in photos. For example, system 102 may provide users with multiple selections directed to specifying and/or consenting to the use of personal information. For example, selections with regard to specifying and/or consenting may be associated with individual photos, all photos, individual photo albums, all photo albums, etc. The selections may be implemented in a variety of ways. For example, system 102 may cause buttons or check boxes to be displayed next to various selections. In one implementation, system 102 enables users of the social network to specify and/or consent to the use of their photos for facial recognition in general.

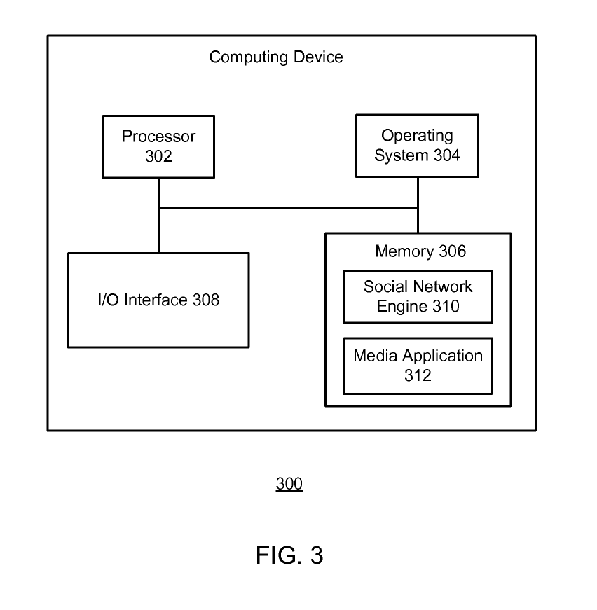

FIG. 3 illustrates a block diagram of an example computing device 300, which may be used to implement the implementations described herein. For example, computing device 300 may be used to implement computing device 104 of FIG. 1 or a user device, as well as to perform at least a portion of one or more method implementations described herein. In some implementations, computing device 300 includes a processor 302, an operating system 304, a memory 306, and an input/output (I/O) interface 308. Computing device 300 also includes a social network engine 310 and a media application 312, which may be stored in memory 306 or on any other suitable storage location or computer-readable medium. Media application 312 provides instructions that enable processor 302 to perform the functions described herein and other functions.

For ease of illustration, FIG. 3 shows one block for each of processor 302, operating system 304, memory 306, I/O interface 308, social network engine 310, and media application 312. These blocks 302, 304, 306, 308, 310, and 312 may represent multiple processors, operating systems, memories, I/O interfaces, social network engines, and media applications. In other implementations, computing device 300 may not have all of the components shown and/or may have other elements including other types of elements instead of, or in addition to, those shown herein.

FIG. 4 is a flowchart of an example machine learning process for providing labels in accordance with some implementations. Processing begins at 402, where an indication of one or more user actions with respect to photo labels is received. The indication can represent a user action of adding a label, deleting an automatically selected label, or modifying an automatically selected label. Indications can be collected from multiple users and aggregated to provide a statistical view of user actions related to photo labels. Processing continues to 404.

At 404, automatic labeling techniques and/or parameters are updated based on the user action statistical information. For example, the user action statistical information can be provided to a machine learning system. The automatic photo labeling system can be tuned using output from the machine learning system in order to better select labels for photos. The aggregating of user action indications and updating of the automatic labeling system can be performed periodically in order to help improve the accuracy of the photo labeling system.

FIG. 5 is a diagram of an example user interface 500 for providing labels for photos in accordance with some implementations. The user interface 500 includes a map portion 502 showing a selected photo 504 (as a thumbnail image) and plurality of other photos 506 on the map. The user interface 500 also includes a label section 508 having one or more labels 510 and an edit element 512. In operation, a user can view the automatically selected labels (e.g., 510) in the label section 508 and then select (e.g., click or tap) the edit element 512 in order to edit the labels 510. Editing operations can include adding new labels, deleting a label or modifying a label. Also, when one of the labels 510 is selected by a user (e.g., by clicking or tapping), the system can search photos for any having the selected label.

The user interface also includes an album name section 514 listing names of any albums the selected photo belongs to. The user interface 500 also includes an author section 516 listing the author's name and any comments from the author that accompanied the posting of the image, and a commenter section 518 listing comment information (e.g., name, comment or snippet of comment, date/time of comment or the like).

The user interface 500 can also include information sections for date image was captured 520, image filename 522 and camera model information (e.g., make, model, lens, settings or the like) 524.

The user interface 500 can provide a user experience that combines automatic photo labeling with manual labeling. For example, a user can add or remove labels and can also edit to make corrections or additions to automatically selected labels. The system can receive indications of the manual actions of the users with respect to the labels. Using these indications, the system can perform machine learning (e.g., unsupervised, semi-supervised or supervised) to adapt techniques used for labeling photos for specific users and/or in general.

When performing searches or displays of labels, the system can be configured to show a group of labels (e.g., 4 or 5 labels) to a user that have been determined by the system to be of particular interest to the user. Thus, there can be a given number of labels (e.g., 4 or 5) presented that can include labels that are likely candidates for searching photos by the user. For example, if a photo is determined by the system to include a person, it may be advantageous to continue on to identify the person if possible and include a label of the person's name rather than just a generic label (e.g., #person).

In another example, if a user takes a photo of a landmark at a park that includes an image of the sky, the system can determine that a label including the name of the landmark or the park may be more descriptive and a better label for searching than a generic label (e.g., #sky).

Also, in some implementations, photos can be labeled or tagged as a batch. When performing batch labeling, the user can be given an option to remove individual photos from the batch before the label is applied. For example, the system has determined that a group of photos can be tagged as snow based on the photo characteristics, but the 4^{th} image is a white sheet and the 10^{th} image is a wedding dress. The user can be provided with an interface that permits the user to exclude the 4^{th} and 10^{th} images from having the label “#snow” applied by the system.

Although the description has been described with respect to particular embodiments thereof, these particular embodiments are merely illustrative, and not restrictive. Concepts illustrated in the examples may be applied to other examples and implementations.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed (e.g., procedural or object-oriented techniques). The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

The memory 306, or data storage and/or nontransitory computer readable medium, can be a magnetic storage device (hard disk drive or the like), optical storage device (CD, DVD or the like), electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Note that the term photo is used to describe an image that is captured with a device. An image is a collection of pixels, which may be generated in a photo or may be generated outside the context of a photo (e.g., using an illustration tool, etc.). Implementations described herein apply to photos and images, depending on the particular implementation.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle or the like. Also, user devices can include wearable computing devices (e.g., glasses, watches and the like), furniture mounted computing devices and/or building mounted computing devices.

Some user devices can be connected to an image processing system via a network. The network connecting user devices to the image processing system can be a wired or wireless network, and can include, but is not limited to, a WiFi network, a local area network, a wide area network, the Internet, or a combination of the above.

The software instructions can also be contained in, and provided as, an electronic signal, for example in the form of software as a service (SaaS) delivered from a server (e.g., a distributed system and/or a cloud computing system).

Moreover, some implementations of the disclosed method, system, and computer readable media can be implemented in software (e.g., as a computer program product and/or nontransitory computer readable media having stored instructions for monochromatic image determination as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for providing labels for photos.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
receiving a plurality of photos;
associating one or more labels with the plurality of photos based on one or more predetermined criteria;
determining one or more suggested labels from the one or more labels to be used as search terms; and
providing the suggested labels for display in a user interface.

2. The method of claim 1, further comprising searching the plurality of photos in response to a selection of one or more of the suggested labels received via the user interface.

3. The method of claim 1, wherein the predetermined criteria includes a criterion based on a source of the photos.

4. The method of claim 1, wherein the predetermined criteria includes a criterion based on visibility of the plurality of photos.

5. The method of claim 1, wherein the predetermined criteria includes a criterion based on ownership of the plurality of photos.

6. The method of claim 1, wherein the predetermined criteria includes a criterion based on a target user being tagged in one or more of the plurality of photos.

7. The method of claim 1, wherein the predetermined criteria includes a criterion based on a type of device used to capture the photos.

8. The method of claim 1, wherein the predetermined criteria includes a criterion based on a brand of device used to capture the photos.

9. The method of claim 1, further comprising presenting the predetermined criteria as corresponding hash tags associated with the plurality of photos.

10. The method of claim 1, wherein the search terms are hash tags associated with the plurality of photos.

11. The method of claim 1, wherein the suggested labels are based on one or more predefined suggestion criteria.

12. The method of claim 1, further comprising:
receiving an indication of a user action related to one or more of the suggested labels; and
updating a label association technique based on the received user action.

13. A system comprising one or more processors configured to perform operations including:
receiving a plurality of photos;
associating one or more labels with the plurality of photos based on one or more predetermined criteria;
determining one or more suggested labels from the one or more labels to be used as search terms; and
providing the suggested labels for display in a user interface.

14. The system of claim 13, wherein the operations further comprise searching the plurality of photos in response to a selection of one or more of the suggested labels received via the user interface.

15. The system of claim 13, wherein the predetermined criteria includes a criterion based on one or more of a source of the photos, visibility of the plurality of photos, ownership of the plurality of photos, a target user being tagged in one or more of the plurality of photos, a type of device used to capture the photos, a brand of device used to capture the photos.

16. The system of claim 13, wherein the operations further comprise:
receiving an indication of a user action related to one or more of the suggested labels; and
updating a label association technique based on the received indication.

17. A nontransitory computer readable medium having stored thereon software instructions that, when executed by a processor, cause the processor to perform operations including:
receiving a plurality of photos;
associating one or more labels with the plurality of photos based on one or more predetermined criteria;
determining one or more suggested labels from the one or more labels to be used as search terms; and
providing the suggested labels for display in a user interface.

18. The nontransitory computer readable medium of claim 17, wherein the operations further comprise searching the plurality of photos in response to a selection of one or more of the suggested labels received via the user interface.

19. The nontransitory computer readable medium of claim 17, wherein the predetermined criteria includes a criterion based on one or more of a source of the photos, visibility of the plurality of photos, ownership of the plurality of photos, a target user being tagged in one or more of the plurality of photos, a type of device used to capture the photos, a brand of device used to capture the photos.

20. The nontransitory computer readable medium of claim 17, wherein the operations further comprise:
receiving an indication of a user action related to one or more of the suggested labels; and
updating a label association technique based on the received indication.
